(19) United States
(12) Patent Application Publication
(10) Pub. No.: US 2015/0135054 A1
(43) Pub. Date: May 14, 2015

(54) Comments on Named Objects

(71) Applicant: Microsoft Corporation, Redmond, WA (US)

(72) Inventors: Catherine Harley, Seattle, WA (US); Marta Luis Burguete, Seattle, WA (US)

(73) Assignee: MICROSOFT CORPORATION, Redmond, WA (US)

(21) Appl. No.: 14/080,213

(22) Filed: Nov. 14, 2013

(51) Int. Cl. G06F 17/24; G06F 3/0481; G06F 3/0486

(52) U.S. Cl. CPC G06F 17/241; G06F 3/0486; G06F 3/04817
USPC 715/230

(57) ABSTRACT

Associating comments with named objects is provided. A document may include a comment attached to a named object (e.g., a chart, a named range, a table, a pivot table, a piece of data in a pivot table, a shape, a picture, a graphic, clip art, an object within an object, etc.). The document may also comprise metadata associated with the comment that may include information such as the named object to which the comment is attached. If the named object is moved, the comment may remain attached to the object and accordingly, may be moved with the object. Attaching a comment to a named object via selecting the comment from a comments pane, dragging, and then dropping the comment onto the named object is also provided.

### BACKGROUND

Modern day users use various software applications to perform a variety of tasks, for example, to write, calculate, draw, organize, send and receive electronic mail, make music, prepare electronic documents such as word processing documents, spreadsheets, presentations, and the like. It is common for a collaborative review process to be used in the development of electronic documents. Typically in such as process, one or more users may access a document, evaluate the content, and deliver feedback and/or changes via comments. Comments may allow users to discuss and annotate content of a document.

Currently, comments may be added to a document and attached to text or to a cell; however, when attaching a comment to an object such as a table, pivot table, chart, picture, graphic, equation, an object within an object, or other named object, the comment may be attached to a cell (in a spreadsheet) or to a location in the document near the object. That is, the comment may not be attached to the object itself. Accordingly, if the object is moved on a page or moved to another page or document or if the layout of the document changes, the comment may not be moved with the object. Currently, if a comment is added to data in a document, for example, to a clip art object in a slide presentation application, the comment may be attached to the current location of the clip art object. Thus, if the clip art object is moved, the comment may remain attached at the previous location of the clip art object and may not move with the object.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing comments on named objects. A document may include a comment that may be attached to a named object such as, but not limited to, a chart, a named range, a table, a pivot table, a piece of data in a pivot table, a shape, a picture, clip art, an object within an object, etc. The document may also comprise metadata associated with the comment that may include such information as an author of the comment, a timestamp, and the named object to which the comment is attached. If the named object is moved, the comment may remain attached to the object and accordingly, may be moved with the object.

Embodiments also provide for attaching a comment to a named object via selecting the comment from a comments pane, dragging, and then dropping the comment onto the named object. Accordingly, an indication of a comment may be displayed by the named object.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of one embodiment of a system for providing a comment on a named object;

FIG. 2 is an example illustration of a document comprising named objects with associated comments;

FIG. 3 is an example illustration of a user selecting a table with an associated comment;

FIG. 4 is an example illustration of a selectable comment icon displayed near the selected table;

FIG. 5 is an example illustration of comments displayed in a comments pane;

FIG. 6 is an example illustration of a document comprising comments associated with a chart object;

FIGS. 7A-7D are example illustrations of a comment displayed in a comments pane attached to a named object via a drag and drop gesture;

FIG. 8A is an example illustration of a comment attached to a shape;

FIG. 8B is an example illustration of the shape in FIG. 8A being moved, and the comment remaining attached to the shape;

FIG. 9 is a flow chart of a method for providing a comment on named object;

FIG. 10 is a block diagram illustrating example physical components of a computing device with which embodiments of the invention may be practiced;

FIGS. 11A and 11B are simplified block diagrams of a mobile computing device with which embodiments of the present invention may be practiced; and

FIG. 12 is a simplified block diagram of a distributed computing system in which embodiments of the present invention may be practiced.

### DETAILED DESCRIPTION

Embodiments of the present invention are directed to providing comments on named objects. As described briefly above, it is common for a collaborative review process to be used in the development of electronic documents. Oftentimes in a collaborative review process, users leave comments on specific portions of a document. Embodiments of the present invention allow for comments to be attached to a named object (e.g., table, pivot table, a piece of data in a pivot table, chart, picture, graphic, an object within an object, or other named object). If the named object is moved, the comment may remain attached to the object and accordingly, may be moved with the object.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

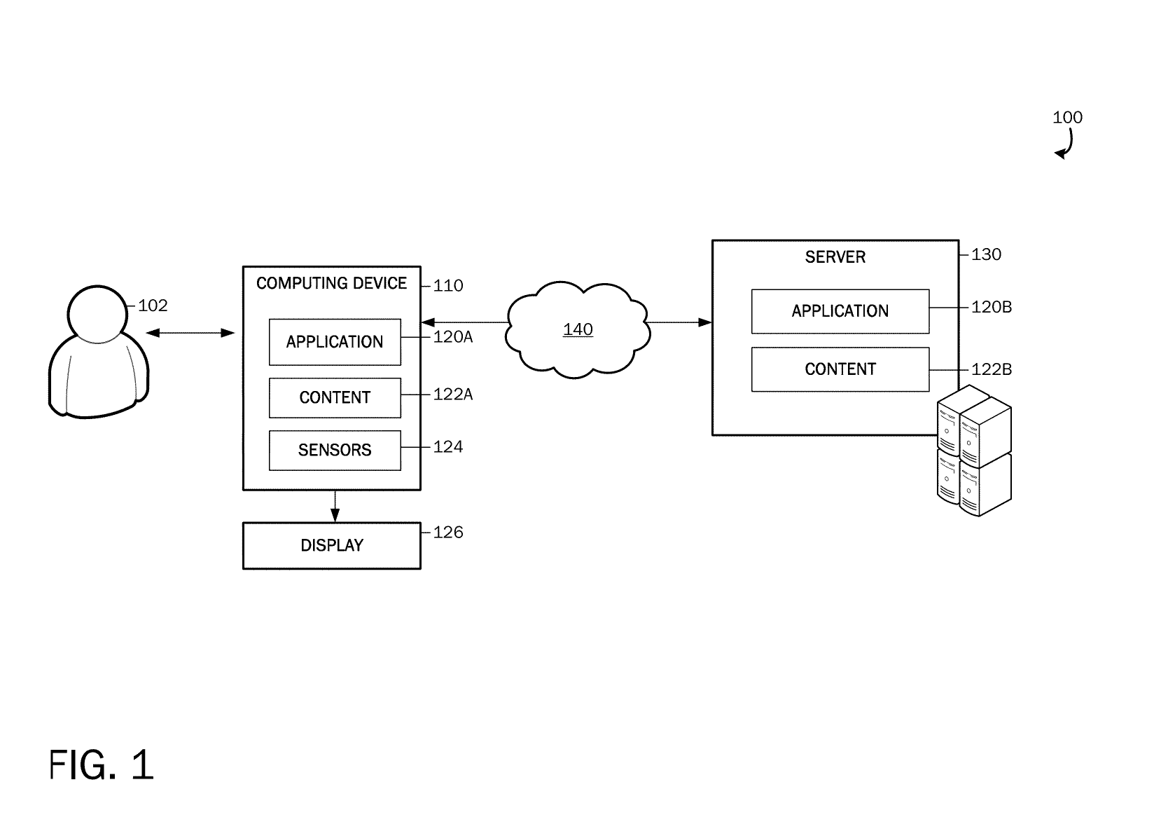

Referring now to the drawings, in which like numerals represent like elements, various embodiments will be described. FIG. 1 is a block diagram illustrating a system architecture 100 for providing comments on named objects. The system architecture 100 includes a computing device 110. The computing device 110 may be one of various types of computing devices (e.g., a tablet computing device, a desktop computer, a mobile communication device, a laptop computer, a laptop/tablet hybrid computing device, a large screen multi-touch display, a gaming device, a smart television, or other types of computing devices) for executing applications 120 for performing a variety of tasks.

A user 102 may utilize an application 120 on a computing device 110 for a variety of tasks, which may include, for example, to write, calculate, draw, organize, prepare presentations, send and receive electronic mail, take and organize notes, make music, and the like. Applications 120 may include thick client applications 120A, which may be stored locally on the computing device 110, or may include thin client applications 120B (i.e., web applications) that may reside on a remote server 130 and accessible over a network 140, such as the Internet or an intranet. A thin client application may be hosted in a browser-controlled environment or coded in a browser-supported language and reliant on a common web browser to render the application executable on a computing device 110.

The computing device 110 may be configured to receive content 122 for presentation on a display 126 (which may comprise a touch screen display). For example, content 122 may include a document comprising one or more displayed graphical elements.

An application 120 may be configured to enable a user 102 to use a pointing device (e.g., a mouse, pen/stylus, etc.) and/or to utilize sensors 124 (e.g., touch sensor, accelerometer, hover, facial recognition, voice recognition, light sensor, proximity sensor, gyroscope, tilt sensor, GPS, etc.) on the computing device 110 to interact with content 122 via a number of input modes. To assist users to locate and utilize functionalities of a given application 120, a user interface (UI) containing a plurality of selectable functionality controls may be provided.

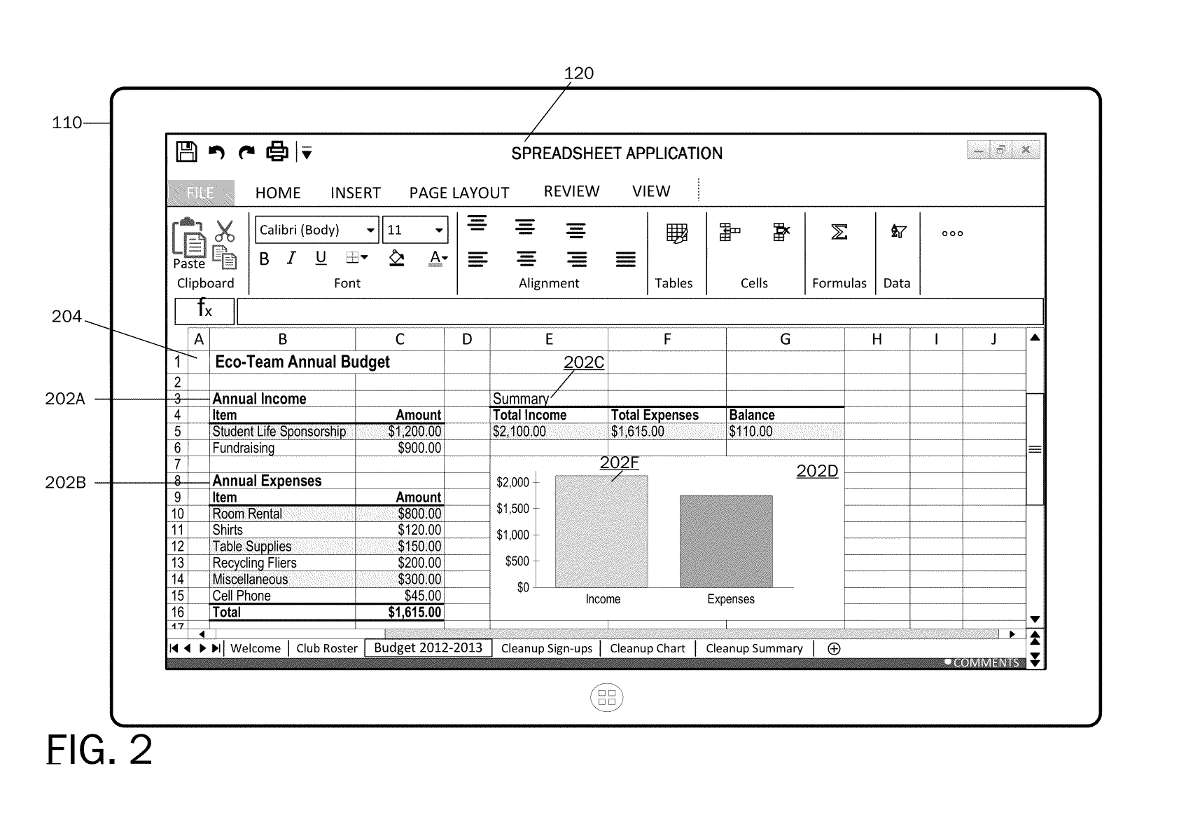

Referring now to FIG. 2, an example illustration of a document 204 comprising a plurality of named objects 202A,B,C,D,F (collectively 202) is shown in an application 120 user interface displayed on a computing device 110. Although illustrated as displayed on a tablet computing device, the application 120 may be executed on various types of computing devices (e.g., a tablet computing device, a desktop computer, a mobile communication device, a laptop computer, a laptop/tablet hybrid computing device, a large screen multi-touch display, a gaming device, a smart television, or other types of computing devices).

A named object 202 may refer to an entity having one or more attributes and/or methods, at least one of which includes an identifier of the object that is referred to as a name of the object. For example, a named object 202 may include a range of cells, a table 202A-C or a pivot table, a chart 202D, a shape, a picture, a graphic, clip art, etc. A named object may also include objects within objects, for example, a piece of data in a pivot table, chart objects (e.g., the bars 202F within the chart 202D).

As illustrated in FIG. 2, the application 120 is a spreadsheet application. Although the example illustrated is an image of a spreadsheet document 204, the document 204 may be one of various types of documents such as, but not limited to, word processing documents, spreadsheet documents, slideshow presentation documents, diagramming and graphic design documents, planning and note-taking documents, etc.

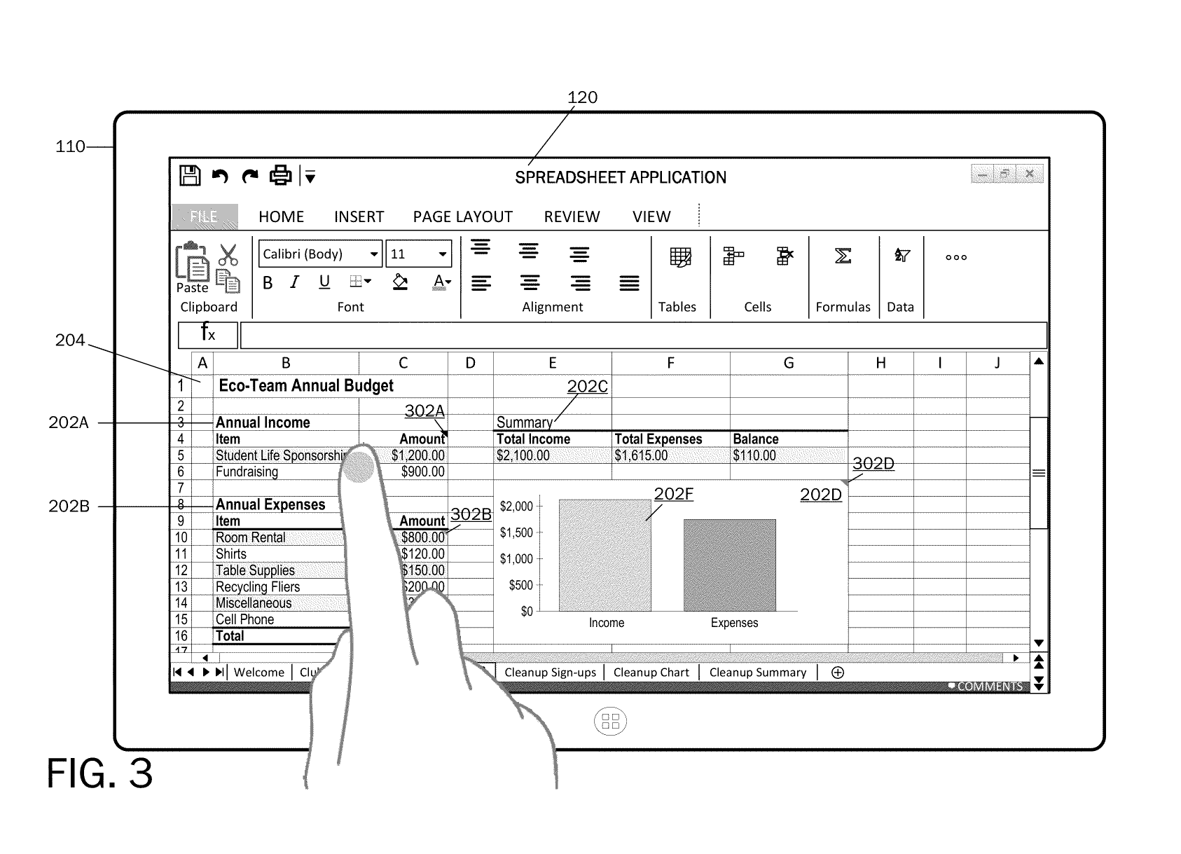

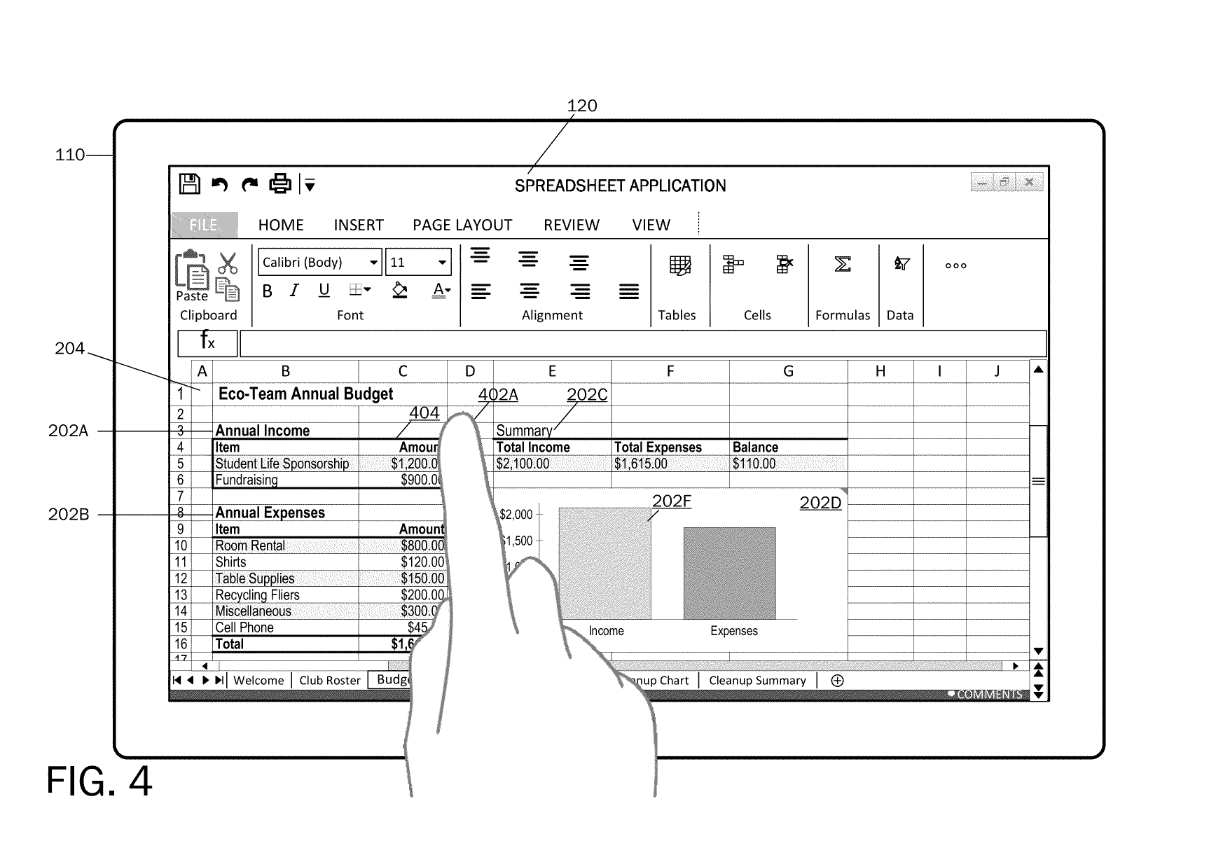

As described above, a comment may be associated with a named object 202. As illustrated in FIG. 3, a comment indicator 302 may be displayed near a named object 202 to which a comment is attached. According to embodiments, a user may select a named object 202 with a comment indicator 302. Accordingly, the named object 202 may be highlighted 404 (e.g., outlined) and a selectable comment icon 402 may be displayed near the selected object. For example and as illustrated in FIG. 3, a user selects a table (named object 202A) with a displayed comment indicator 302A in the spreadsheet (document 204). As illustrated in FIG. 4, the table (named object 202A) is highlighted, and a selectable comment icon 402A is displayed near the selected named object 202A.

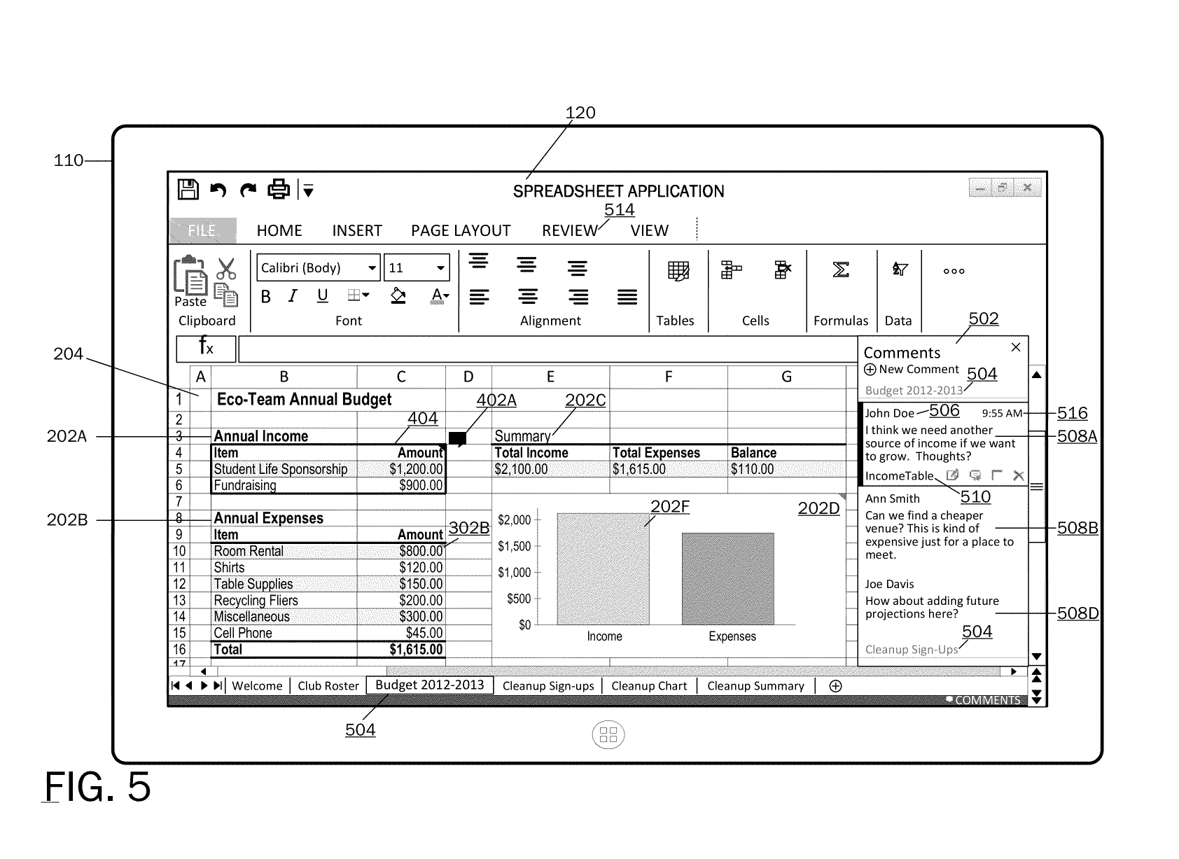

Referring now to FIG. 5, according to embodiments, a selection of a comment icon 402 may provide a display of comments 508 in a comments pane 502. Other methods may be used to display comments 508, for example, via a selection of a show comments command in a review tab 514, via right-clicking an object comprising a comment 508 and selecting a show comments command, etc. As illustrated, comments 508 may be sorted by object 202 and by page 504. For example, comments 508A, 508B, and 508D may be associated with named objects 202A, 202B, and 202D respectively in the “Budget 2012-2013” page 504 of the spreadsheet (document 204).

Metadata associated with a comment 508 may be displayed with the comment 508. Comment metadata may comprise such information as the page 504 comprising the named object 202 to which the comment 508 is attached, an author 506 of the comment 508, a timestamp 516 of the comment 508, and a name 510 of the named object 202 to which the comment 508 is attached. For example and as illustrated in FIG. 5, comment 508A is displayed in the comments pane 502. The comment metadata includes the author 506 “John Doe,” a timestamp “9:55 AM,” the named object's name 510 “IncomeTable,” and is sorted under the “Budget 2012-2013” page 504. The selected comment 508A may be highlighted as illustrated. Other comments 508 in the document 204 may also be displayed in the comments pane 502.

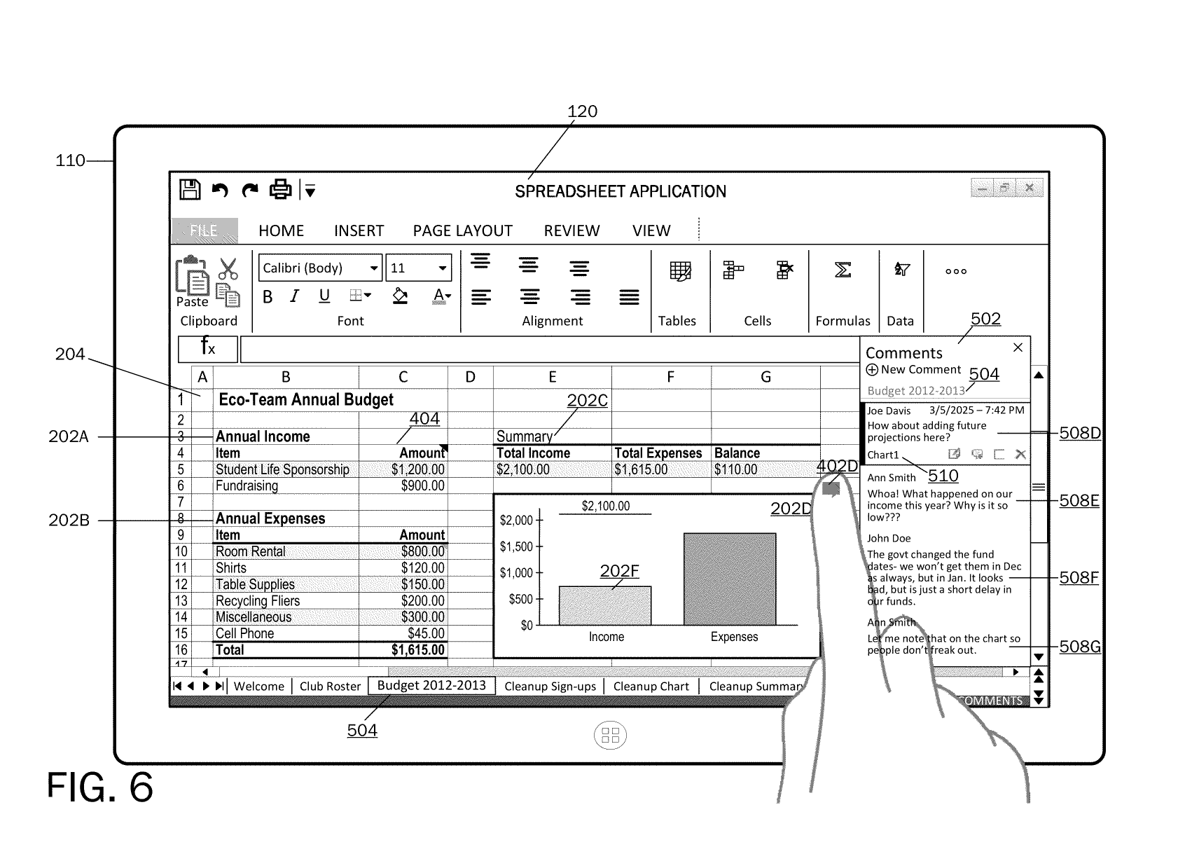

FIG. 6 shows an example of comments 508D,E,F,G associated with a chart (named object 202D) displayed in a comments pane 502. For example, the user may select a comment icon 402D displayed near the chart (named object 202D). Accordingly, the comments 508D,E,F,G associated with the chart may be displayed.

A comment 508 may be attached to a named object 202 via various mechanisms (e.g., selection of an add comment command, selection of a contextual menu item, etc.). According to embodiments, a comment 508 may be attached to a named object 202 via dragging and dropping existing data onto the named object 202. The data may exist in the form of a comment 508, data in the document 204, or data in an integrated communication solution (e.g., a message in an integrated chat).

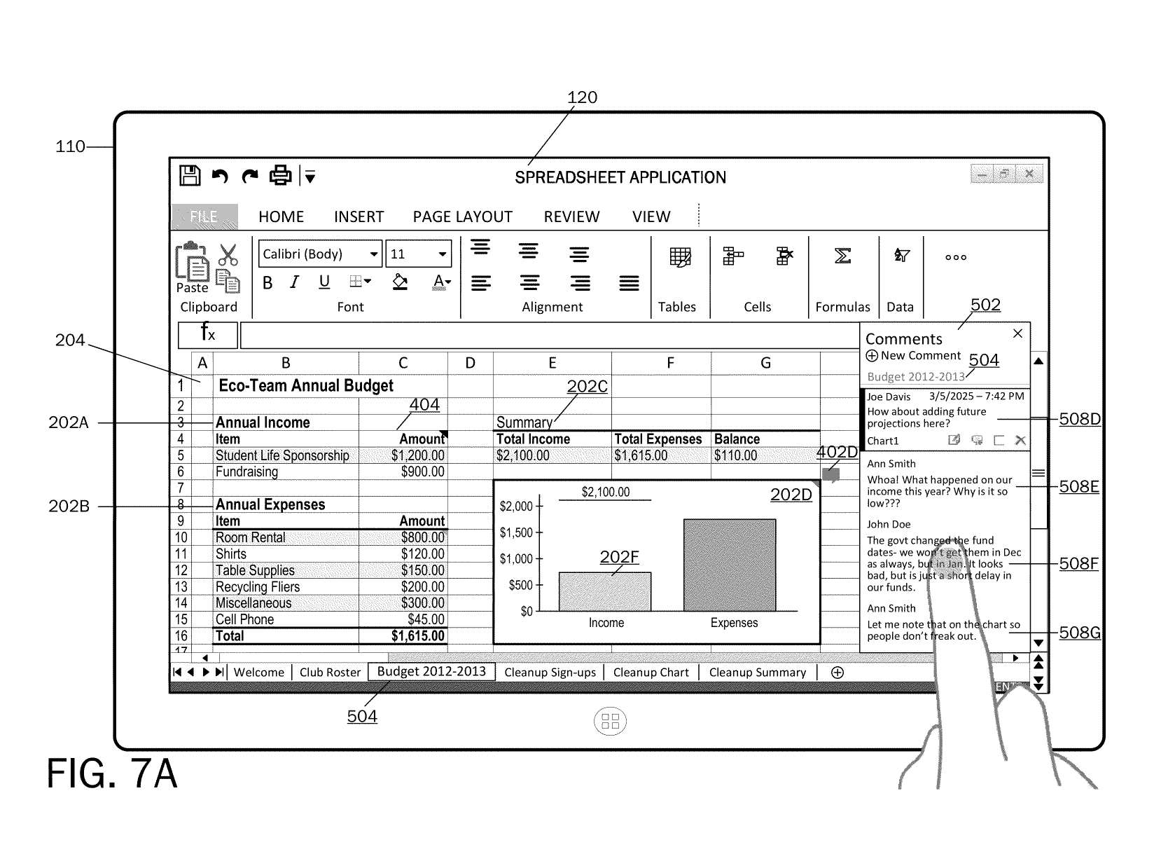

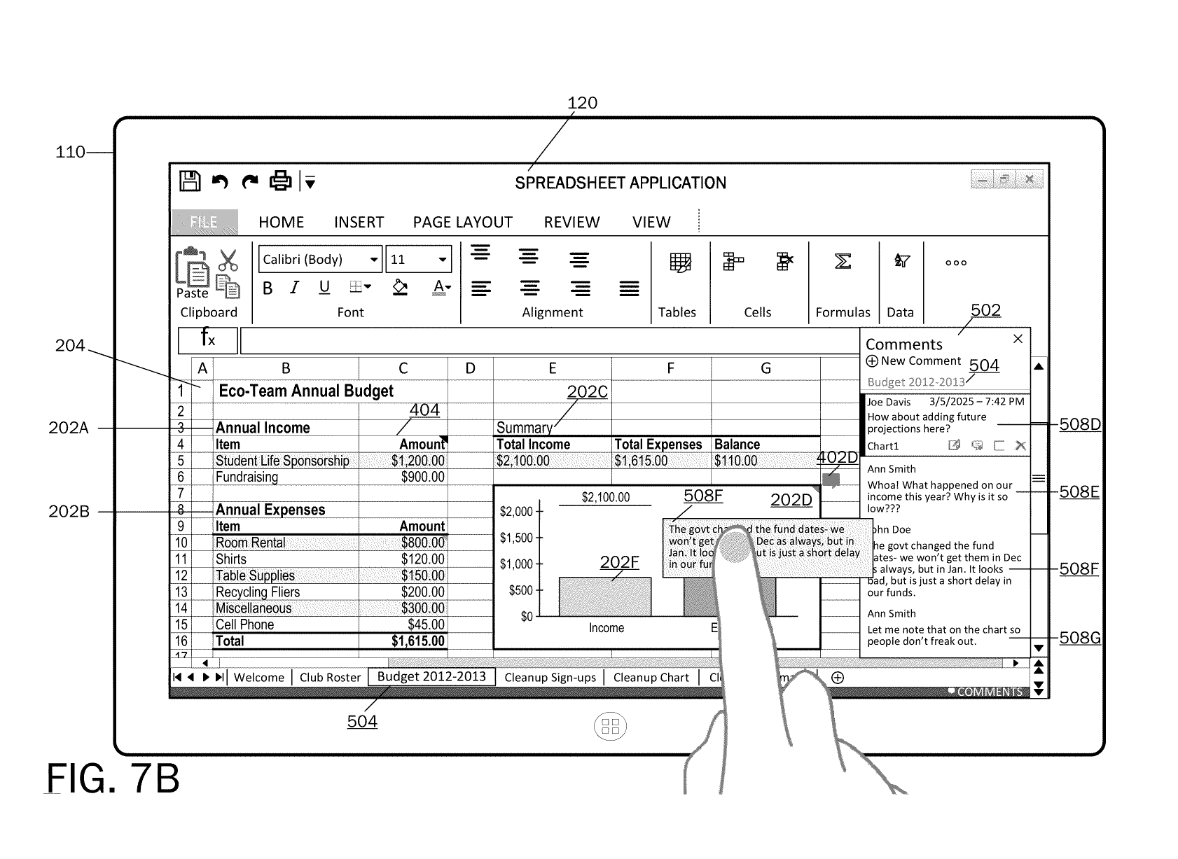

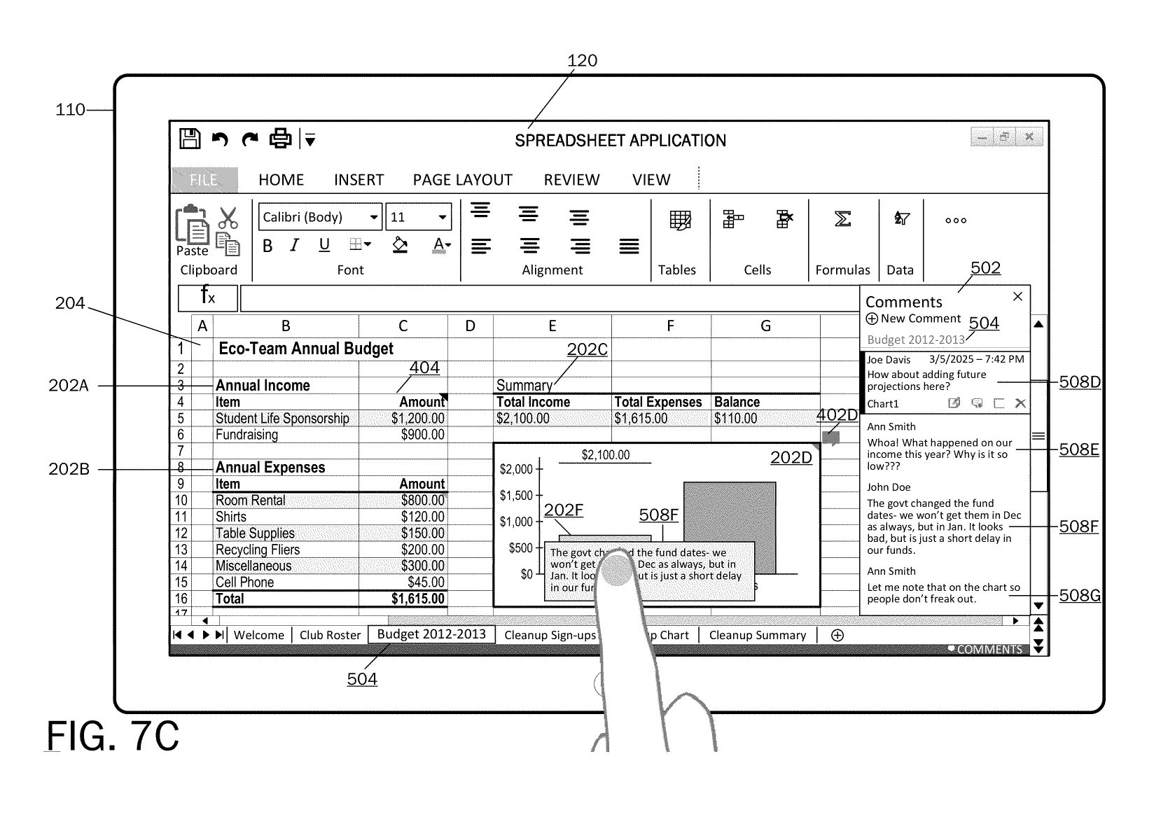

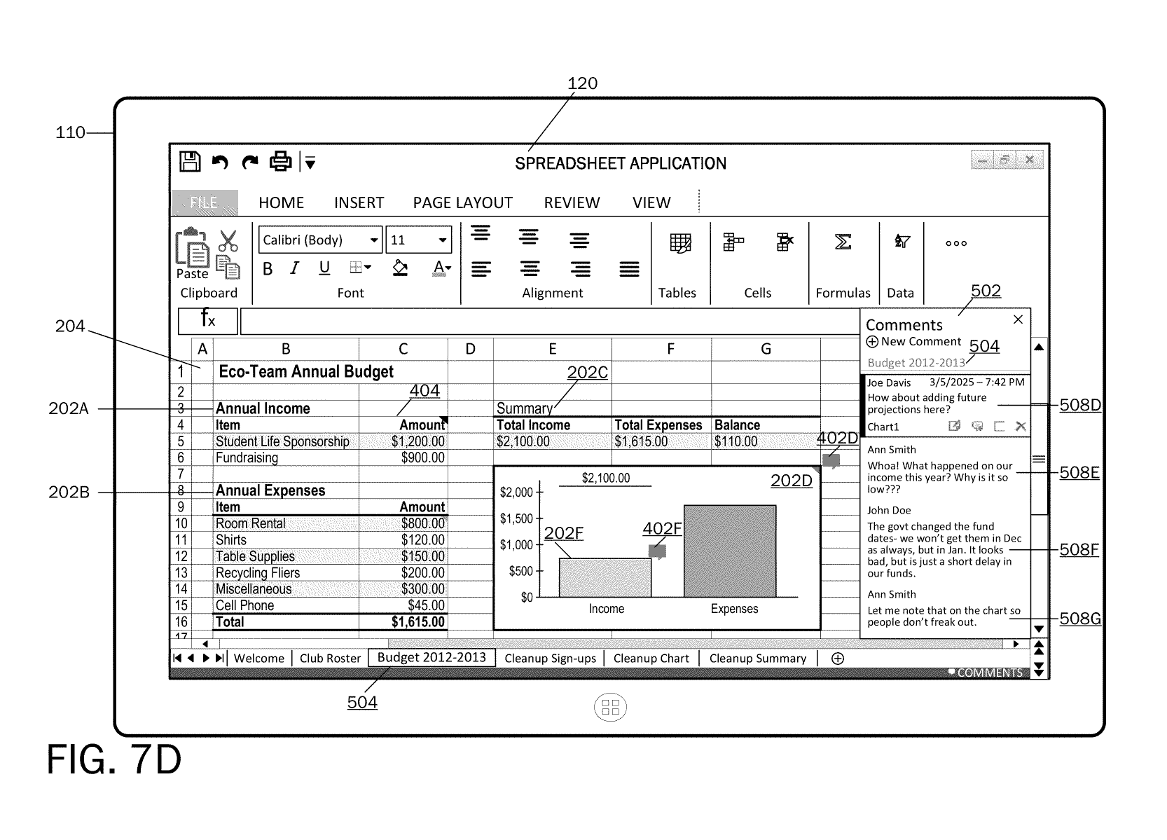

FIGS. 7A-7D show an example of a comment 508F displayed in a comments pane 502 dragged and dropped onto a named object 202F. Referring now to FIG. 7A, data, such as a comment 508F may be selected. As illustrated in FIG. 7B, the data (e.g., comment 508F) may be dragged. FIG. 7C shows the data (e.g., comment 508F) being dragged and dropped onto a bar (named object 202F) of a bar chart (named object 202D). As described above, the data may then be attached to the named object 202F as a comment 508. As illustrated in FIG. 7D, when data has been attached to the named object 202F as a comment 508, a selectable comment icon 402F may be displayed near the named object 202F to which it is attached.

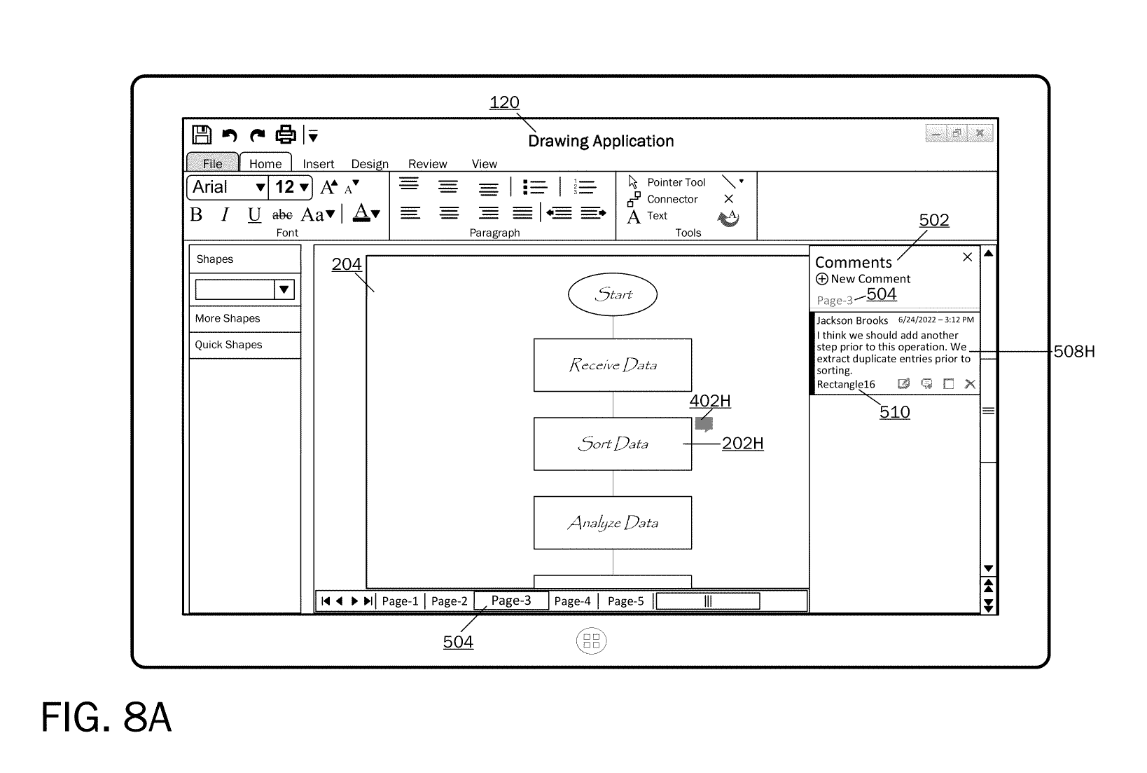

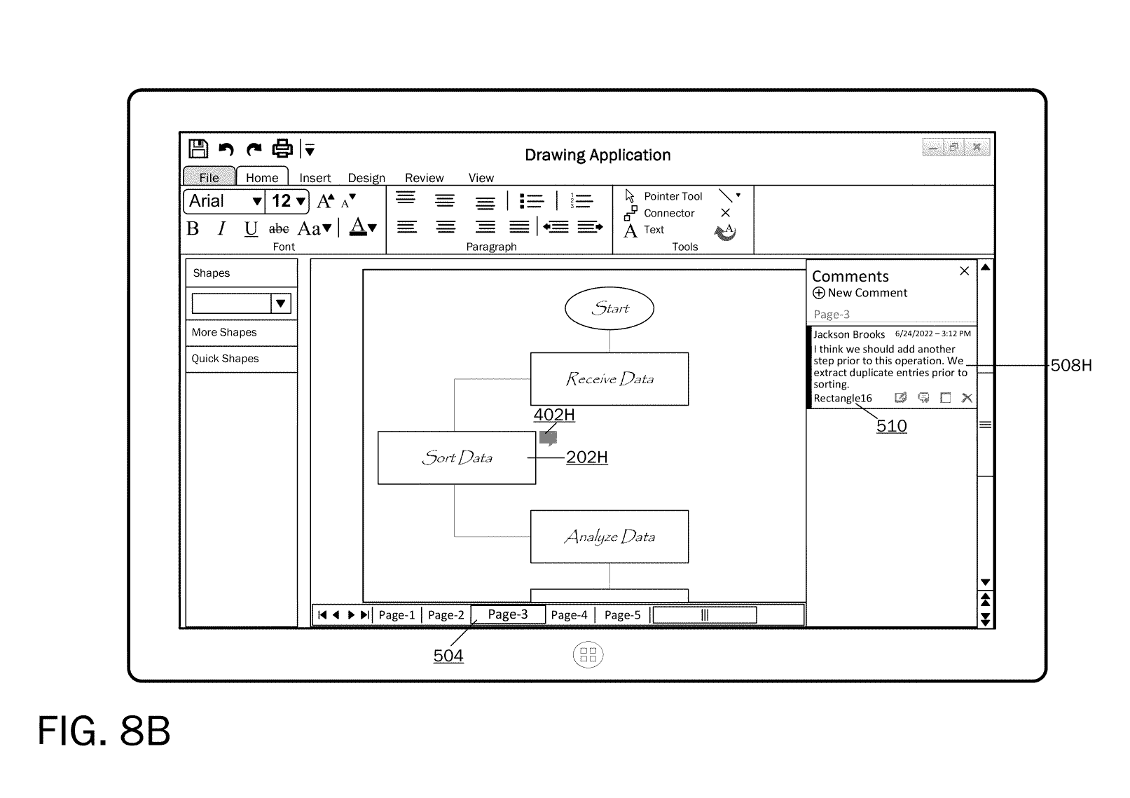

As mentioned previously, a comment 508 may be attached to a named object 202 in a variety of document 204 types in a variety of applications 120. As illustrated in FIGS. 8A-8B, an example comment 508H is attached to a named object 202H in a graphic design document 204 in a drawing application 120. As illustrated, the comment 508H is attached to a shape; as shown in the comment metadata, the name 510 of the named object 202H to which the comment 508H is attached is “Rectangle16.”

According to embodiments, when a named object 202 is moved, for example, on a same page 504 or onto another page 504 or document 204, a comment 508 attached to the named object 202 may remain attached to the named object and may move with it. For example and as illustrated in FIG. 8B, the shape (named object 202H) is moved. Accordingly, the comment 508H remains attached to the shape (named object 202H). A comment indicator, which may be a comment icon 402H, may continue to be displayed with the shape (named object 202H).

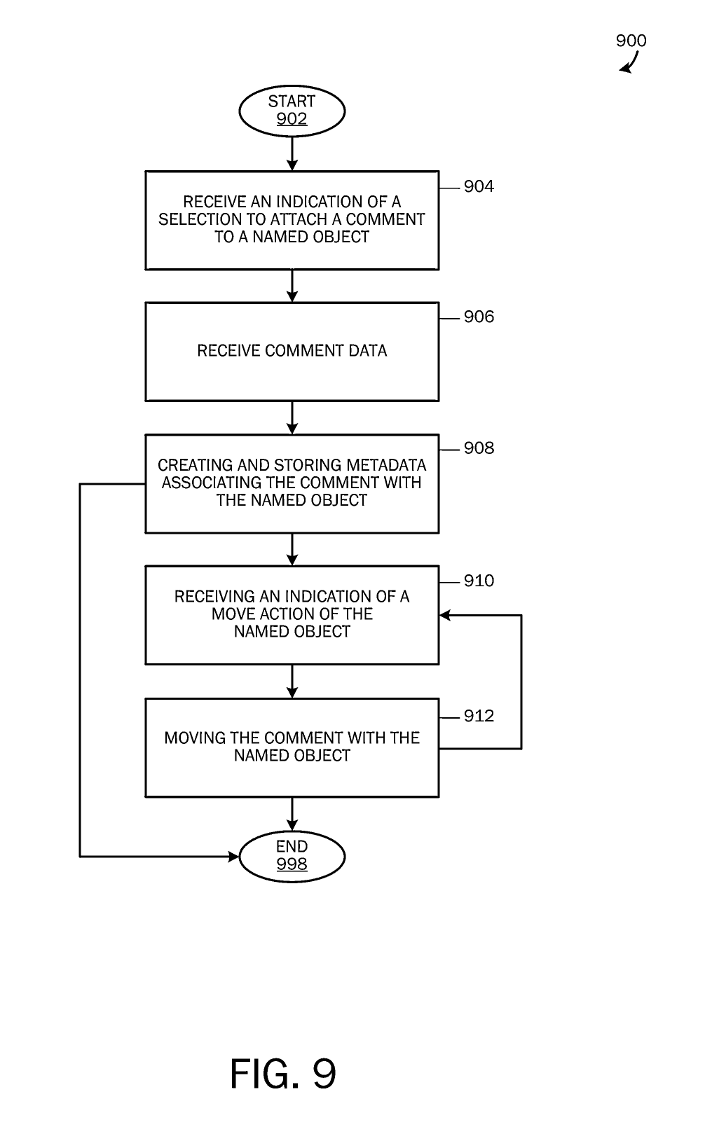

FIG. 9 is a flow chart showing one embodiment of a method 900 for providing comments on named objects. The method 900 starts at OPERATION 902 and proceeds to OPERATION 904 where an indication of a selection to attach a comment 508 to a named object 202 in a document 204 is received. As described above, various mechanisms may be used to selectively attach a comment 508 to a named object 202. For example, a user may right-click on the named object 202 and select an “insert comment” command from a contextual menu, may press keyboard shortcut keys to create a new comment 508, may select to add a new comment via selecting a “new comment” command button from a user interface command menu, selecting to add a new comment 508 in a comment task pane 502, or by drag-and-dropping existing data in the document 204 onto the named object 202 (as illustrated in FIGS. 7A-7D).

The method 900 may then proceed to OPERATION 906 where comment data may be received. For example, a user may type data into a comment text box, may paste data into a comment text box, or may drag-and-drop data onto the named object 202. According to embodiments, the comment data may include text or may include an object, for example, a chart, table, picture, graphic, etc.

Once comment data is received, the method 900 may proceed to OPERATION 908, where metadata associating the comment 508 with the named object 202 may be created and stored. For example, the metadata may include the name 510 of the named object 202 to which the comment 508 is attached.

The method 900 may then end at OPERATION 998, or may proceed to OPERATION 910 where an indication of a move activity of the named object 202 is received. For example, a user may select to move the named object 202 elsewhere on the page 504 or to another document 204, may change the layout of the named object 202, or may choose to sort or filter data within the named object 202.

The method 900 may then proceed to OPERATION 912 where the comment 508 remains attached to the named object 202, and accordingly is moved with the named object 202. The method 900 may end at OPERATION 998.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

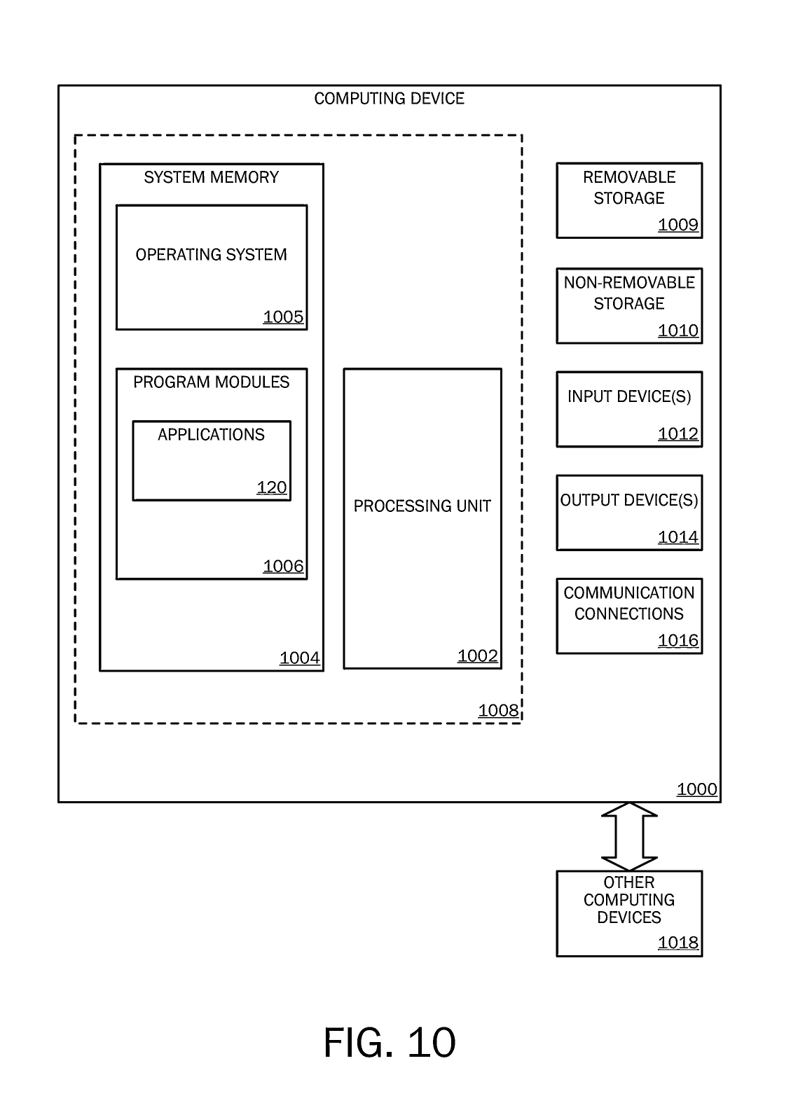

FIGS. 10-12 and the associated descriptions provide a discussion of a variety of operating environments in which embodiments of the invention may be practiced. However, the devices and systems illustrated and discussed with respect to FIGS. 10-12 are for purposes of example and illustration and are not limiting of a vast number of computing device configurations that may be utilized for practicing embodiments of the invention, described herein.

FIG. 10 is a block diagram illustrating physical components (i.e., hardware) of a computing device 1000 with which embodiments of the invention may be practiced. The computing device components described below may be suitable for the computing devices described above. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for running software applications 120. The operating system 1005, for example, may be suitable for controlling the operation of the computing device 1000. Furthermore, embodiments of the invention may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 may perform processes including, but not limited to, one or more of the stages of the method 900 illustrated in FIG. 9. Other program modules that may be used in accordance with embodiments of the present invention may include applications 120, such as, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing visual feedback indicating that a graphical element is included in a selection boundary prior to a commitment of a selection may be operated via application-specific logic integrated with other components of the computing device 1000 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1000 may also have one or more input device(s) 1012 such as a keyboard, a mouse, a pen, a sound input device, a touch input device, etc. The output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

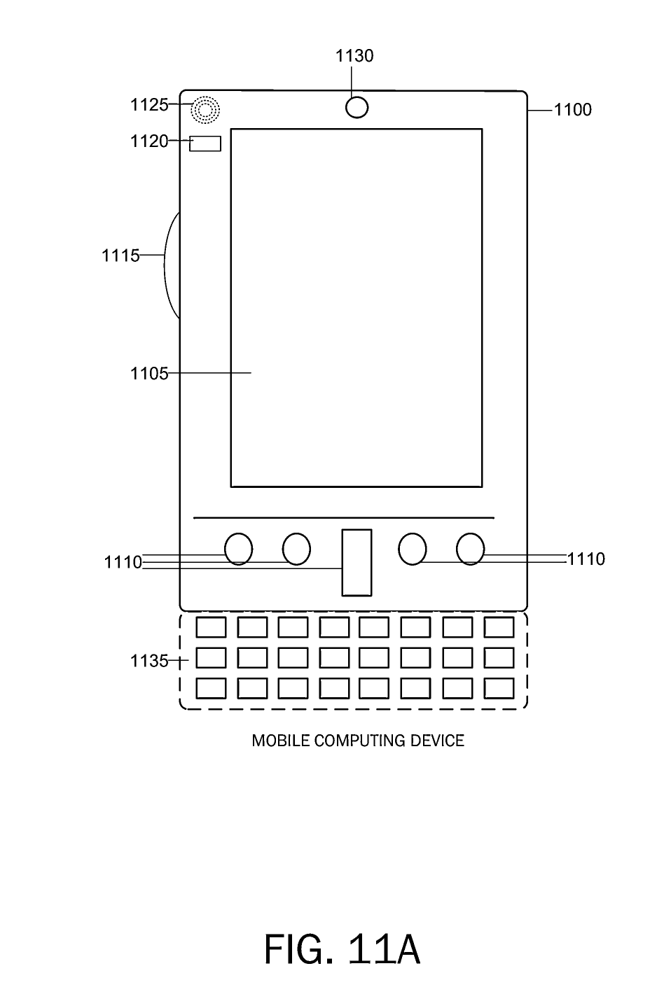

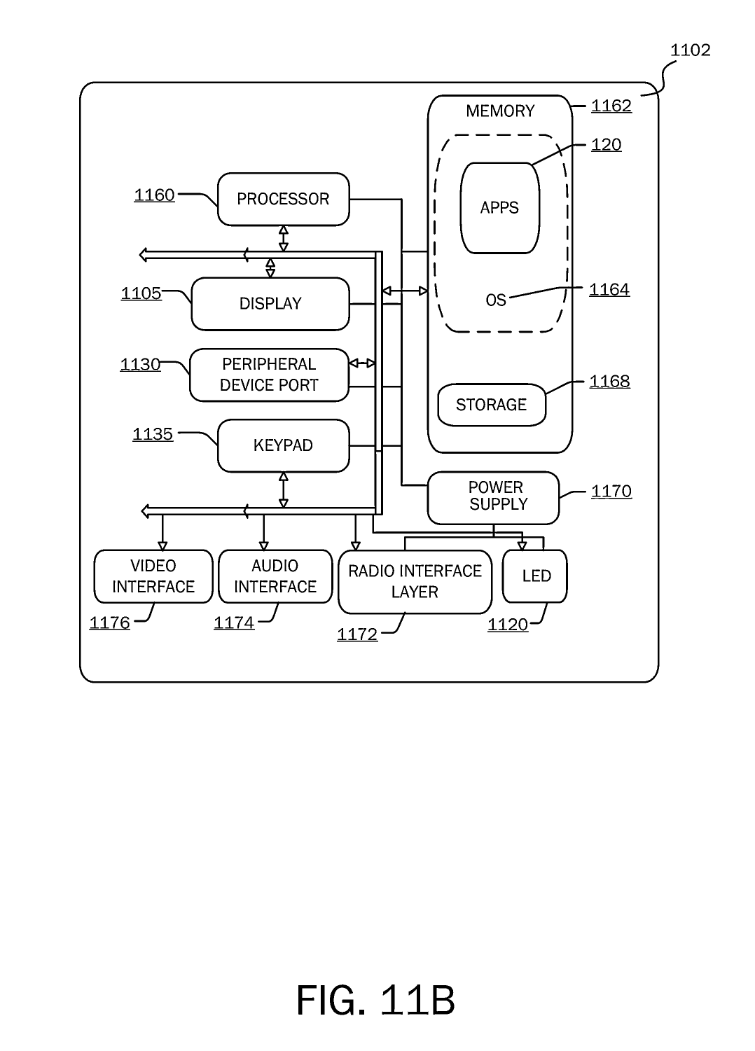

FIGS. 11A and 11B illustrate a mobile computing device 1100, for example, a mobile telephone, a smart phone, a tablet personal computer, a laptop computer, and the like, with which embodiments of the invention may be practiced. With reference to FIG. 11A, one embodiment of a mobile computing device 1100 for implementing the embodiments is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The display 1105 of the mobile computing device 1100 may also function as an input device (e.g., a touch screen display). If included, an optional side input element 1115 allows further user input. The side input element 1115 may be a rotary switch, a button, or any other type of manual input element. In alternative embodiments, mobile computing device 1100 may incorporate more or less input elements. For example, the display 1105 may not be a touch screen in some embodiments. In yet another alternative embodiment, the mobile computing device 1100 is a portable phone system, such as a cellular phone. The mobile computing device 1100 may also include an optional keypad 1135. Optional keypad 1135 may be a physical keypad or a “soft” keypad generated on the touch screen display. In various embodiments, the output elements include the display 1105 for showing a graphical user interface (GUI), a visual indicator 1120 (e.g., a light emitting diode), and/or an audio transducer 1125 (e.g., a speaker). In some embodiments, the mobile computing device 1100 incorporates a vibration transducer for providing the user with tactile feedback. In yet another embodiment, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one embodiment of a mobile computing device. That is, the mobile computing device 1100 can incorporate a system (i.e., an architecture) 1102 to implement some embodiments. In one embodiment, the system 1102 is implemented as a “smart phone” capable of running one or more applications (e.g., browser, e-mail, calendaring, contact managers, messaging clients, games, and media clients/players). In some embodiments, the system 1102 is integrated as a computing device, such as an integrated personal digital assistant (PDA) and wireless phone.

One or more application programs 120 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 120 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio 1172 that performs the function of transmitting and receiving radio frequency communications. The radio 1172 facilitates wireless connectivity between the system 1102 and the “outside world,” via a communications carrier or service provider. Transmissions to and from the radio 1172 are conducted under control of the operating system 1164. In other words, communications received by the radio 1172 may be disseminated to the application programs 120 via the operating system 1164, and vice versa.

The visual indicator 1120 may be used to provide visual notifications and/or an audio interface 1174 may be used for producing audible notifications via the audio transducer 1125. In the illustrated embodiment, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone to receive audible input, such as to facilitate a telephone conversation. In accordance with embodiments of the present invention, the microphone may also serve as an audio sensor to facilitate control of notifications, as will be described below. The system 1102 may further include a video interface 1176 that enables an operation of an on-board camera 1130 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio 1172 or via a distributed computing network. Similarly, such data/information may be readily transferred between computing devices for storage and use according to well-known data/information transfer and storage means, including electronic mail and collaborative data/information sharing systems.

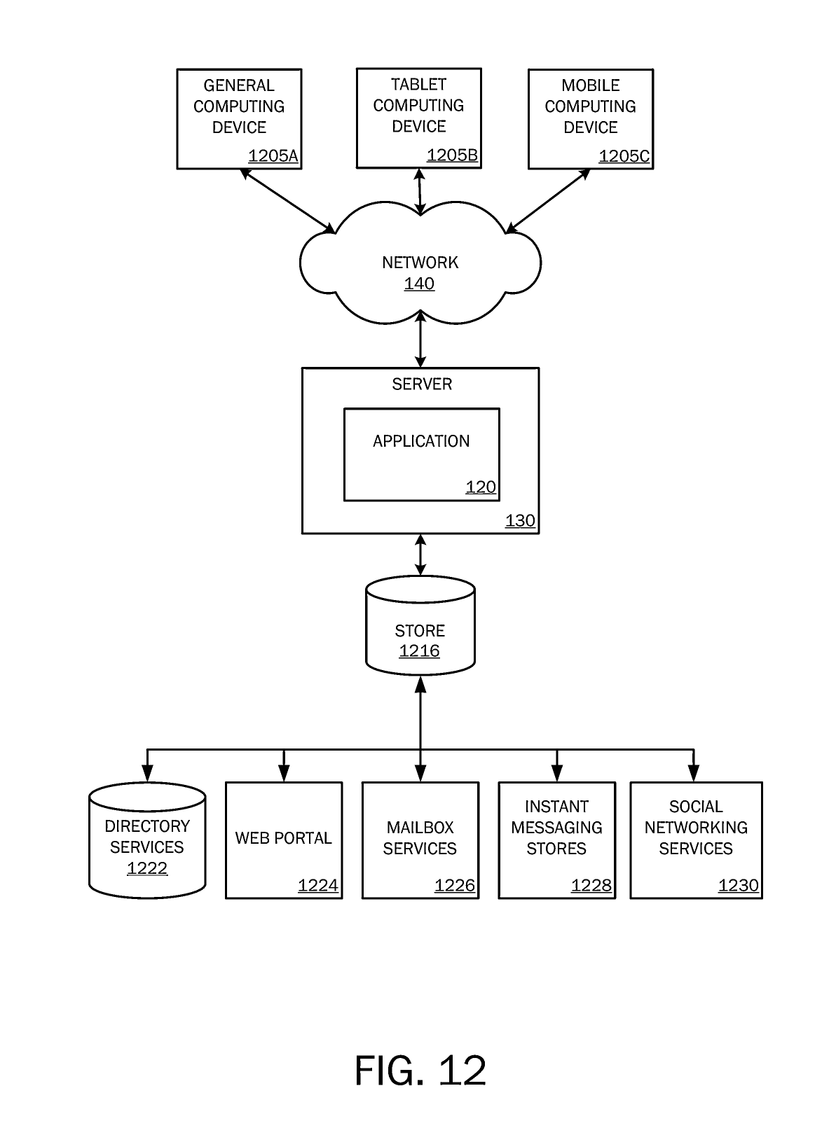

FIG. 12 illustrates one embodiment of the architecture of a system for providing comments 508 on named objects 202, as described above. Content developed, interacted with, or edited in association with an application 120 may be stored in different communication channels or other storage types. For example, various documents may be stored using a directory service 1222, a web portal 1224, a mailbox service 1226, an instant messaging store 1228, or a social networking site 1230. The application 120 may use any of these types of systems or the like for enabling data utilization, as described herein. A server 130 may provide the application 120 to clients. As one example, the server 130 may be a web server providing the application 120 over the web. The server 130 may provide the application 120 over the web to clients through a network 140. By way of example, the client computing device may be implemented and embodied in a personal computer 1205A, a tablet computing device 1205B and/or a mobile computing device 1205C (e.g., a smart phone), or other computing device 110. Any of these embodiments of the client computing device 1205A, 1205B, 1205C, 110 may obtain content from the store 1216.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing a comment on a named object, the method comprising:
receiving a selective indication to attach a comment to a named object;
receiving comment data; and
creating and storing metadata associating the comment with the named object.

2. The method of claim 1, wherein receiving a selective indication to attach a comment to a named object comprises receiving a selective indication to attach a comment to one of:
a range of cells;
a table;
a pivot table;
a piece of data in a pivot table;
a chart;
a shape;
a picture;
a graphic;
clip art; or
an object within an object.

3. The method of claim 1, wherein receiving a selective indication to attach a comment to a named object comprises receiving an indication of a drag and drop of data onto the named object.

4. The method of claim 3, wherein receiving an indication of a drag and drop of data onto the named object comprises receiving an indication of a drag and drop of one or more of:
text;
a table;
a piece of data in a pivot table;
a pivot table;
a chart;
a shape;
a picture;
a graphic; or
clip art.

5. The method of claim 1, wherein creating and storing metadata associating the comment with the named object comprises associating a name of the named object with the comment.

6. The method of claim 1, further comprising:
receiving an indication of a move action on the named object; and
moving the comment with the named object.

7. The method of claim 1, further comprising:
receiving an indication of a selection of the named object;
providing a selectable comment icon near the named object;
receiving an indication of a selection of the selectable comment icon; and
providing a display of the comment.

8. The method of claim 7, wherein providing a display of the comment comprises displaying the comment in a comments pane.

9. A system for providing a comment on a named object, the system comprising:
one or more processors; and
a memory coupled to the one or more processors, the one or more processors operable to:
receive a selective indication to attach a comment to a named object;
receive comment data; and
create and store metadata associating the comment with the named object.

10. The system of claim 9, wherein the named object comprises one of:
a range of cells;
a table;
a pivot table;
a piece of data in a pivot table;
a chart;
a shape;
a picture;
a graphic;
clip art; or
an object within an object.

11. The system of claim 9, wherein the one or more processors are operable to receive a selective indication to attach a comment to a named object by receiving an indication of a drag and drop of data onto the named object.

12. The system of claim 9, wherein in creating and storing metadata associating the comment with the named object, the one or more processors are operable to associate a name of the named object with the comment.

13. The system of claim 9, wherein the one or more processors are further operable to:
receive an indication of a move action on the named object; and
move the comment with the named object.

14. The system of claim 9, wherein the one or more processors are further operable to:
receive an indication of a selection of the named object;
provide a selectable comment icon near the named object;
receive an indication of a selection of the selectable comment icon; and
provide a display of the comment.

15. A computer readable medium containing computer executable instructions which, when executed by a computer, perform a method for providing a comment on a named object, the method comprising:
receiving a selective indication to attach a comment to a named object, wherein the named object is an entity having one or more attributes and/or methods, at least one of which includes an identifier of the object that is referred to as a name of the named object;
receiving comment data; and
creating and storing comment metadata, the comment metadata associating the comment with the named object and including the name of the named object.

16. The computer readable medium of claim 15, wherein receiving a selective indication to attach a comment to a named object comprises receiving a selective indication to attach a comment to one of:
a range of cells;
a table;
a pivot table;
a piece of data in a pivot table;
a chart;
a shape;
a picture;
a graphic;
clip art; or
an object within an object.

17. The computer readable medium of claim 15, wherein receiving a selective indication to attach a comment to a named object comprises receiving an indication of a drag and drop of data onto the named object.

18. The computer readable medium of claim 17, wherein receiving an indication of a drag and drop of data onto the named object comprises receiving an indication of a drag and drop of one or more of:
text;
a table;
a pivot table;
a piece of data in a pivot table;
a chart;
a shape;
a picture;
a graphic; or
clip art.

19. The computer readable medium of claim 15, further comprising:
receiving an indication of a move action on the named object; and
moving the comment with the named object.

20. The computer readable medium of claim 15, further comprising:
receiving an indication of a selection of the named object;
providing a selectable comment icon near the named object;
receiving an indication of a selection of the selectable comment icon; and
providing a display of the comment.
